(19) United States
(12) Patent Application Publication
(10) Pub. No.: US 2009/0206277 A1
(43) Pub. Date: Aug. 20, 2009

(54) Nanoparticles as agents for imaging finger prints

(76) Inventors: Frederick John Rowell, Durham (GB); Brenden John Theaker, Tees Valley (GB)

Correspondence Address: KLARQUIST SPARKMAN, LLP, 121 SW SALMON STREET, SUITE 1600, PORTLAND, OR, 97204, US

(21) Appl. No.: 10/585,523

(22) PCT Filed: Jan. 7, 2005
(86) PCT No.: PCT/GB05/00038

§ 371 Date: Mar. 12, 2009

(30) Foreign Application Priority Data
Jan. 7, 2004 (GB) 0400235.8

(51) Int. Cl. G01N 21/64; B32B 5/16; C09K 11/06

(52) U.S. Cl. 250/459.1; 428/402; 428/403; 252/301.16; 977/773; 977/927; 250/216

(57) ABSTRACT

This invention relates to a novel analytical method for detecting prints, for example fingerprints, and to nanoparticles suitable for conducting such methods.

This invention relates to a novel analytical method and to nanoparticles suitable for conducting such methods.

Fingerprints may be formed under a number of circumstances. The first involves transfer of a material such as blood or paint from the surface of the finger onto a surface. Alternatively the surface of the finger itself may cause an impression on a wet surface such as blood or paint, or leave an indentation in a plastic or malleable surface such as putty. In these and other examples, a clear print is often formed without the need to enhance or develop the print.

In a further alternative circumstance, contact of the finger on a surface may leave residues on the surface due to transfer of naturally occurring chemicals secreted from the skin. Such prints are termed latent fingerprints and they generally require treatment to render them visible. The chemical entities are derived from secretions from the eccrine and apocrine sweat glands and the sebaceous glands. Generally the major contributions are from the eccrine glands on the palms of the hand and the sebaceous glands from other areas of the skin. The major components of the secretions from the eccrine glands, are water (initially 98-99% but quickly lost through evaporation), anions including chloride, cations, amino acids, proteins urea, lactic acid and glucose—and from the sebaceous glands fatty acids, triglycerides, cholesterol, squalene, cholesteryl esters and wax esters.

To date a variety of strategies have been used to enhance the visibility of latent fingerprints. These include the use of specific methods targeted at a component within the print, and general methods which use a physical characteristic rather than a specific chemical interaction. Examples of the former include use of silver nitrate to form dark precipitates with chloride ions, use of ninhydrin which reacts with amino acids forming purple dyes, Amido black that sticks to proteins, iodine, Gentian violet and Sudan black that react with fatty acids. Examples of non-specific agents include super glue and dusting powders that stick to the hydrophobic, sebum-derived components of the prints.

U.S. Pat. No. 6,485,981 describes a method and apparatus for imaging and documenting fingerprints. A fluorescent dye brought in intimate proximity with the lipid residues of a latent fingerprint is caused to fluoresce on exposure to light energy. The resulting fluorescing image may be recorded photographically.

There is also a range of finely powdered dusting agents based on metals, carbon and lycopodium. Examples include fluorescent latent print powders that comprise different fluorescent dyes and can also have components that render them magnetic for ease of application.

Use of these reagents generally leads to prints that can be readily identified by their ridge patterns and their patterns of irregularity so that the overall characteristics can be used to identify the “owner” of the print. This may be problematic for prints deposited on porous surfaces or when only traces of the print are present.

We have now developed novel agents for developing latent fingerprints. These novel agents comprise fluorescent nanoparticles, generally formed as sol gel particles in the presence of fluorescent dye derivatives so that fluorescent nanoparticles are produced.

Thus, in the first aspect of the invention, we provide a fluorescent nanoparticle.

Preferably the nanoparticles of the invention sol gel-derived nanoparticles can be rendered fluorescent by entrapping biological macromolecules labelled with a variety of fluorescent reporter molecules. Examples of such combinations include Texas Red and fluorescein for proteins and ethidium bromide for DNA. The former dyes are covalently attached to the macromolecule and for the latter the dye molecule is intercalated with the DNA. Alternatively any nanoparticles having intrinsic fluorescence such as those derived from cadmium sulphide and cadmium selenide (and doped with rare earth atoms such as europium III salts) can be used.

The size of the nanoparticles may vary, however, it is preferred that the nanoparticles, which may be substantially spherical, may have a diameters of from 30 to 500 nm.

A variety of fluorescent dyes have been used based on entrapment of protein-dye conjugates within the nanoparticles during their preparation. Examples of dyes include Texas Red-labelled gelatin and porcine thyroglobulin, and fluorescein-labelled bovine serum albumin and gelatin.

Sol gels' processing generally comprises the formation of a dual phase material of a solid polymer matrix skeleton filled with a solvent through a sol gel transition. When the solvent is removed, the gel converts to a xerogel. Sol gels have been widely used as matrices in a variety of analytical systems, including for encapsulation of biological macromolecules such as proteins and enzymes or even whole cells.

In a biological application, the sol gel process comprises the preparation of an insoluble framework or cage in which the biological entity is entrapped or encapsulated.

Such particles can be modified by passive adsorption or via covalent attachment to coat their surfaces with hydrophobic molecules which facilitates their binding to hydrophobic deposits derived from latent fingerprints on surfaces. Examples of hydrophobic molecules include phosphatidylcholine and phosphatidylethanolamine although any hydrophobic molecule could in theory be used.

Sol gel-derived nanoparticles with a Texas Red-porcine thyroglobulin conjugate embedded within, have been shown to bind to latent fingerprints on surfaces as shown by the fluorescence of the Texas Red dye.

Since nanoparticles are much smaller than metal particles currently used to locate passive fingerprints it should be possible to discern greater details of the substructures of prints and to use this new detail to identify the originators of fingerprints with greater accuracy, even with incomplete prints. It should also be possible to use the high fluorescence intensity of the particles on the surface to improve the sensitivity of detection for such fingerprints.

We have modified the surfaces of these particles so that we can attach a variety of surface coatings to them. For finger print development the final coating is a lipophilic (“water-hating”) bio-compatible chemical that preferentially binds to the sebum-derived components such as waxes, cholesterol and squalene. Examples of such lipophilic chemicals include phosphatidylcholine and phosphatidylethanolamine. To achieve this coating, we have either passively adsorbed the chemicals directly onto sol gel particles formed from TEMOS (tetramethyloxysilane) via electrostatic interactions, or have covalently coupled them to the particles using aminopropyloxysilane-derived sol gels. In the latter case attachment was via glutaraldehyde treatment followed by cyanoborohydride reduction and then washing with ethanolamine to reduce non-specific binding.

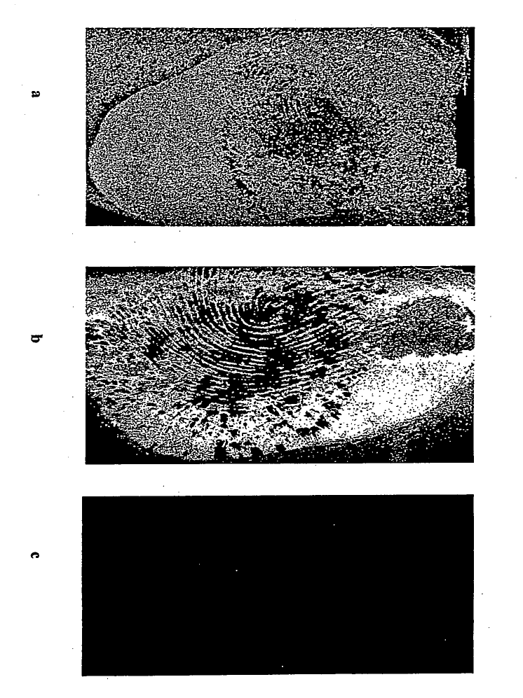

We have also prepared other sol gel-derived nanoparticles that are coated with hydrophilic (“water-loving”) chemicals carrying either net negative or net positive charges. An example of the former includes uncoated nanoparticles whilst an example of the latter includes nanoparticles coated with polylysine. When we apply these hydrophilic particles to a finger print and scan the surface for fluorescence due to fluorescent dyes embedded within the particles, some fluorescence is seen but no development of the characteristic patterns is observed (FIG. 1a). This scanning was performed at an excitation wavelength of 595 nm and an emission of 612 nm when Texas Red dye was used. In contrast when the hydrophilic-coated particles are used, patterns of irregularity are clearly visible demonstrating selective binding to the sebum-derived components on the surface (FIG. 1b). When no nanoparticles are added then no fluorescence is seen (FIG. 1c)

1. A nanoparticle, which encapsulates a fluorescent material, wherein the nanoparticle comprises a fluorescent dye based on entrapment of a protein-dye conjugate or a DNA-dye conjugate within the nanoparticle.

2. A nanoparticle according to claim 1, wherein the nanoparticle is derived from a sol gel.

3. A nanoparticle according to claim 1, wherein the nanoparticle is intrinsically fluorescent.

4. A nanoparticle according to claim 3, wherein the nanoparticle is derived from cadmium sulphide and cadmium selenide optionally doped with rare earth atoms.

5. A nanoparticle according to claim 4, wherein the rare earth atom is europium III salt.

6. A nanoparticle according to claim 1, wherein the nanoparticle is substantially spherical and has a diameter of 30 to 500 nm.

7. A nanoparticle according to claim 1, wherein the dye is selected from Texas Red-labelled gelatin, porcine thyroglobulin, and fluorescein-labelled bovine serum albumin or gelatin.

8. A nanoparticle according to claim 1, wherein the surface of the nanoparticle is modified to enable the nanoparticle to be provided with a surface coating.

9. A nanoparticle according to claim 8, wherein the nanoparticle is capable of being modified by passive adsorption or via covalent attachment to coat its surface with hydrophobic molecules.

10. A nanoparticle according to claim 9, wherein the hydrophobic molecules are selected from phosphatidylcholine and phosphatidylethanolamine.

11. A nanoparticle according to claim 2, wherein the sol gel-derived nanoparticle comprises a Texas Red-porcine thyroglobulin conjugate embedded within the nanoparticle.

12. A nanoparticle according to claim 1, wherein the particle comprises a high fluorescence intensity nanoparticle.

13. A nanoparticle according to claim 1, wherein the surface coating is lipophilic.

14. A nanoparticle according to claim 1, wherein the particle is adapted to bind to a sebum-derived component.

15. A nanoparticle according to claim 14, wherein the sebum-derived component is selected from the group comprising waxes, cholesterol and squalene.

16. A nanoparticle according to claim 13, wherein the surface coating is selected from phosphatidylcholine and phosphatidylethanolamine.

17. A nanoparticle according to claim 8, wherein the coating is passively adsorbed directly onto the sol gel particle.

18. A nanoparticle according to claim 1, wherein the nanoparticle is formed from TEMOS (tetramethyloxysilane).

19. A nanoparticle according to claim 18, wherein the nanoparticle comprises an aminopropyloxysilane-derived sol gel.

20. A method of preparing the nanoparticle according to claim 19, comprising preparing the nanoparticle by glutaraldehyde treatment.

21. The method of preparing a nanoparticle according to claim 20, further comprising reducing the nanoparticle by cyanoborohydride reduction following the glutaraldehyde treatment.

22. The method of preparing a nanoparticle according to claim 21, further comprising washing the nanoparticle with an ethanolamine wash following the cyanoborohydride reduction.

23. A nanoparticle according to claim 1, wherein the nanoparticle is an uncoated nanoparticle and carries either a net negative or a net positive charge.

24. A nanoparticle according to claim 1, wherein the nanoparticle is provided with a hydrophilic coating.

25. A nanoparticle according to claim 24, wherein the coating carries either a net negative or a net positive charge.

26. A nanoparticle according to claim 24, wherein the hydrophilic coating comprises polylysine.

27. A method of detecting fingerprints which comprises determining details of fingerprint substructures with the nanoparticle according to claim 1.

28. (canceled)

29. The method according to claim 27, wherein determining details of fingerprint substructures includes scanning the fingerprint substructures at an excitation wavelength that induces the fluorescent material to fluoresce.

30. The method according to claim 29, wherein the scanning is at an excitation wavelength of 595 nm.
